(19) United States
(12) Patent Application Publication
(10) Pub. No.: US 2019/0367309 A1
(43) Pub. Date: Dec. 5, 2019

(54) BRUSH ROLL

(71) Applicant: BHS Corrugated Maschinen- und Anlagenbau GmbH, Weiherhammer (DE)

(72) Inventors: Michael HIRMER, Wernberg-Koblitz (DE); Lukas STOLZ, Weiden (DE)

(21) Appl. No.: 16/418,205

(22) Filed: May 21, 2019

(30) Foreign Application Priority Data
May 30, 2018 (DE) 10 2018 208 607.9

(51) Int. Cl. B65H 20/02; B65H 35/00; B31F 1/28

(52) U.S. Cl. CPC B65H 20/02; B31F 1/2845; B65H 35/008

(57) ABSTRACT

A brush roll configured to support a material web, in particular a web of corrugated board, comprises a roll core and arcuate shells, which are each arranged on the roll core and comprise bristles arranged on the outside. The brush roll further has fastening assemblies configured to fasten the arcuate shells to the roll core. Each of the fastening assemblies has a fastening body, which is locally fastened to the roll core, which locally fastens at least one of the arcuate shells to the roll core, which has a foot part, connected to the roll core, with a bottom, and a head part, connected to the foot part, with a lower side facing the roll core, said lower side forming at least one lower wedge face for engagement with at least one of the arcuate shells.

### CROSS-REFERENCE TO RELATED APPLICATIONS

This application claims the priority of German Patent Application, Serial No. DE 10 2018 208 607.9, filed on May 30, 2018, pursuant to 35 U.S.C. 119(a)-(d), the content of which is incorporated herein by reference in its entirety as if fully set forth herein.

### FIELD OF THE INVENTION

The invention relates to a brush roll configured to support a material web, in particular a web of corrugated board. The invention is further directed at an arcuate shell, in particular for a brush roll of this type. The invention is also directed at a fastening body, in particular for a brush roll of this type. The invention further relates to a cutting device comprising at least one brush roll of this type for cutting a material web, in particular a web of corrugated board. The invention is further directed at a corrugated board plant comprising at least one cutting device of this type.

### BACKGROUND OF THE INVENTION

Brush rolls for cutting devices of corrugated board plants are known, for example, from DE 10 2005 024 425 A1 of the applicant. These brush rolls haven proven well in practical application.

DE 20 2007 000 269 U1 discloses a hollow roll, which is used as a transport and transfer roll in paper processing machines, for example. The hollow roll has a roll jacket, which has a plurality of hollow profile segments. The hollow profile segments are clamped by means of a clamping device. The clamping device comprises clamping rings with outer L-shaped clamping claws, which—in the mounted condition—come into engagement with clamping hooks of the hollow profile segments. The clamping claws of the clamping rings are arranged in a mutually opposing configuration. This hollow roll is not particularly user-friendly. Further, its true running properties are often not satisfactory.

From DE 352 688, a field roll is known, which comprises a roll core and segment pieces arranged thereon. Each segment piece has a dovetailed pin on its inside, which engages a complementary dovetailed groove of a belt arranged on the outside of the roll core.

U.S. Pat. No. 3,942,210 discloses a rotary brush construction for use in car wash. The brush construction comprises a hub assembly, which is arranged on a carrier shaft. A plurality of brush shells is secured to the hub assembly by means of screws, which radially pass through the openings in the shells and engage boreholes of the hub assembly.

From EP 2 923 602 A1, a brush core is known, which carries brush holders and is insertable into a snow brush machine. Each brush holder comprises two dovetailed pins on its inside, which—in the mounted condition—engage complementary grooves of the brush core.

### SUMMARY OF THE INVENTION

The invention is based on the object of providing an improved brush roll. In particular, the brush roll is intended to be extremely user-friendly, in particular easy to assemble and disassemble, and to have particularly good true running properties. A corresponding arcuate shell and a corresponding fastening body are to be provided as well. Furthermore, a corresponding cutting device and corrugated board plant are to be provided.

According to the invention, this object is achieved by the features of a brush roll configured to support a material web, in particular a web of corrugated board, said brush roll comprising a roll core, arcuate shells, which are each arranged on the roll core and comprise bristles arranged on an outside, and fastening assemblies configured to fasten the arcuate shells to the roll core, with each of the fastening assemblies having a fastening body, which is locally fastened to the roll core, locally fastens at least one of the arcuate shells to the roll core, has a foot part with a bottom, said foot part being connected to the roll core, and a head part, connected to the foot part, with a lower side facing the roll core, said lower side forming at least one lower wedge face for engagement with at least one of the arcuate shells.

In another aspect of the invention, this object is achieved by an arcuate shell, in particular for a brush roll according to the invention, said arcuate shell comprising at least one outwardly facing wedge face for interaction with at least one lower wedge face of at least one fastening body.

In yet another aspect of the invention, this object is achieved by a fastening body, in particular for a brush roll according to the invention, for local fastening to a roll core of a brush roll and for locally fastening at least one arcuate shell to the roll core, said fastening body comprising a foot part with a bottom, and a head part, connected to the foot part, with a lower side, wherein said lower side forms at least one lower wedge face for engagement with at least one arcuate shell.

In yet another aspect of the invention, this object is achieved by a cutting device with at least one knife and with at least one brush roll according to the invention to support a material web, in particular a web of corrugated board, when cutting said material web using the at least one knife.

In yet another aspect of the invention, this object is achieved by a corrugated board plant with at least one brush roll according to the invention.

The essence of the invention is the at least one lower wedge face of the fastening body. The at least one wedge face is preferably plane. In the assembled condition of the brush roll, the lower wedge face preferably exerts a normal force on the at least one arcuate shell associated to the fastening body, said normal force passing by a center axis of the brush roll, in other words it does not pass through said center axis. Advantageously, it urges, in particular presses and/or pulls, as it were, the at least one arcuate shell in the direction of the roll core and, at the same time, along the lower wedge face, in other words essentially in the circumferential direction around the roll core or the brush roll. It is expedient if the at least one arcuate shell is not fastened by the fastened fastening body in relation to the roll core in an axial, radial and/or circumferential direction relative to the center axis of the brush roll.

Preferably, the at least one brush roll supports the material web during cutting. It is preferably cylindrical.

The roll core is advantageously cylindrical. It is preferably rotatable or mounted such as to be drivable for rotation.

It is expedient if the shells are each configured in the shape of a segment of a circular arc. Preferably, between two and four arcuate shells extend about the roll core in the circumferential direction so as to completely surround the roll core in its circumferential direction. It is advantageous if a plurality of arcuate shells are arranged axially adjacent to each other in relation to the center axis of the brush roll or along the length thereof. Advantageously, the arcuate shells arranged on the roll core form a closed jacket, in particular brush jacket, which surrounds the circumference of the roll core preferably completely.

The arcuate shells are preferably identical in design. Each arcuate shell is advantageously symmetrical in relation to a transverse plane and/or a longitudinal plane, which extends along the arcuate shell or the brush roll. It is expedient if at least one fastening body is arranged between two arcuate shells arranged adjacent to one another in the circumferential direction of the brush roll. Each fastening body is preferably configured in one piece, and is preferably configured in the manner of an anvil. The head part and the foot part of a fastening body are connected to each other directly or indirectly. Each foot part is connected directly or indirectly to the roll core. It is expedient if the fastening bodies are made of a plastic material or of metal. Each fastening body is preferably symmetrical in relation to at least one center plane.

The cutting device is preferably part of a longitudinal cutting/creasing assembly.

Advantageously, the corrugated board plant has at least one corrugated board production device for the production of at least one single-face laminated web of corrugated board. Preferably, it further comprises a device for producing a double-face laminated web of corrugated board from the at least one single-face laminated web of corrugated board and a laminating web.

The lower transverse plane of the fastening body with which the at least one lower wedge face forms a lower wedge angle in a range between 5° and 45° runs preferably perpendicular to the at least one center plane of the respective fastening body.

The at least one lower wedge face, which runs towards the bottom of the associated foot part laterally from outside, is capable, for example, of urging the at least one shell interacting therewith away from the associated fastening body in the circumferential direction of the brush roll. Furthermore, it holds the at least one arcuate shell on the roll core securely and firmly.

It is expedient if the at least one lower wedge face is circumferential. The head part protrudes beyond the foot part preferably on all sides.

Each fastening screw passing through the fastening body of the associated fastening assembly in order to locally fasten said fastening body to the roll core has preferably a threaded shank with an external thread and a head with an in particular internal torque application means, the head being nonrotationally connected to the threaded shank. Advantageously, fastening screw or threaded shank receiving openings with internal threads, which are complementary to the external threads of the fastening screws, are formed in the roll core. It is expedient if each fastening body has an inner shoulder, such as an annular shoulder, against which the associated fastening screw abuts in the mounted condition. Each fastening body is adapted to be fastened to the roll core in a preferably detachable manner.

The brush roll configured such that the lower side of the respective head part forms two lower wedge faces, which engage two arcuate shells arranged adjacent to one another in a circumferential direction of the brush roll, is particularly easy to assemble and disassemble. Advantageously, two arcuate shells arranged adjacent to one another in the circumferential direction of the brush roll share at least one fastening body. Each fastening body is preferably essentially T-shaped, in particular when seen in a longitudinal sectional view. Preferably, the two lower wedge faces protrude from two mutually opposing side faces of the associated foot part. Advantageously, the two lower wedge faces protrude from the associated foot part in mutually opposite directions.

In one preferred embodiment, the two lower wedge faces run towards the bottom of the associated foot part laterally from outside in an oblique configuration, in other words they are arranged in the shape of a V. Preferably, they urge the two arcuate shells arranged adjacent to one another in the circumferential direction of the brush roll away from one another. Preferably, the form a lower tip angle, which is between 125° and 175°.

The at least one upper wedge face formed by a respective upper side, which faces away from the roll core, of each of the fastening bodies for engagement with at least one of the arcuate shells is preferably plane. It is preferably arranged opposite the at least one lower wedge face of the respective fastening body.

In one preferred embodiment, the at least one upper wedge face forms an upper wedge angle in relation to an upper transverse plane of the fastening body, said angle being in the range between 5° and 45°. It is expedient if, in absolute values, the upper wedge angle corresponds essentially to the lower wedge angle of the respective fastening body. The upper transverse plane is preferably perpendicular to the at least one center plane of the respective fastening body and parallel to the lower transverse plane of said fastening body.

It is advantageous if the at least one upper wedge face runs laterally away from the outside of the bottom of the associated foot part. Advantageously, the thickness of the head part reduces laterally towards the outside because of the at least one lower wedge face and/or the at least one upper wedge face.

The brush roll configured such that the upper side of the respective head part forms two upper wedge faces, which engage two arcuate shells arranged adjacent to one another in a circumferential direction of the brush roll, is again particularly easy to assemble and disassemble.

The at least one outwardly facing wedge face of each arcuate shell configured such that the at least one lower wedge face of at least one fastening body abuts against said at least one outwardly facing wedge face is preferably plane, and not only allows the respective arcuate shell to be held, by means of the associated fastening body, on the roll core securely and particularly without play but also allows the arcuate shell to be urged in the circumferential direction of the brush roll. Advantageously, the at least one outwardly facing wedge face of the arcuate shell is in each case arranged in the circumferential end areas of the arcuate shell. It is expedient if—in the mounted condition of the arcuate shells—the at least one lower wedge face of the head part of a fastening body is in a surface-to-surface contact with the associated at least one outwardly facing wedge face of the arcuate shell.

It is advantageous if an outer wedge angle of the at least one outwardly facing wedge face of an arcuate shell corresponds or essentially corresponds to the lower wedge angle of the at least one lower wedge face of a fastening body.

In one preferred embodiment, the at least one inwardly facing wedge face and outwardly facing wedge face of an arcuate shell for a fastening body are preferably arranged in pairs in a mutually opposing configuration. Advantageously, they define a head part receiving opening, which is open in the circumferential direction of the brush roll, to receive a head part of the fastening body. The at least one inwardly facing wedge face is preferably plane. Preferably, said inwardly facing wedge face not only allows the respective arcuate shell to be held on, or clamped in relation to, the roll core by means of the associated fastening body but also allows the arcuate shell to be urged in the circumferential direction of the brush roll. Preferably, the at least one upper wedge face of a fastening body is in a surface-to-surface contact with the at least one inwardly facing wedge face of the arcuate shell. It is advantageous if an inner wedge angle of the at least one inwardly facing wedge face of an arcuate shell corresponds or essentially corresponds to the upper wedge angle of the at least one upper wedge face of a fastening body.

A preferred embodiment of the invention will hereinafter be described by way of example with reference to the enclosed drawing.

### BRIEF DESCRIPTION OF THE DRAWING

FIG. 1 shows a simplified side view of a longitudinal cutting/creasing assembly with a cutting device according to the invention;

FIG. 2 shows a longitudinal sectional view of a cutting device of the longitudinal cutting/creasing assembly shown in FIG. 1 along section line II-II in FIG. 1;

FIG. 3 shows a cross-sectional view of the brush roll according to the invention as shown in FIGS. 1, 2 along section line III-III in FIG. 2;

FIG. 4 shows a detail view of FIG. 3, providing an enlarged view of a fastening assembly of the brush roll;

FIG. 5 shows a partly exploded view of the brush roll shown in FIGS. 1, 2, 3;

FIG. 6 shows an inside view of an arcuate shell according to the invention of the brush roll illustrated in FIGS. 1, 2, 3, 5;

FIG. 7 shows a perspective view of an arcuate shell of the brush roll illustrated in FIGS. 1, 2, 3, 5;

FIG. 8 shows the detail of the arcuate shell marked in FIG. 7;

FIG. 9 shows a cross-sectional view of an arcuate shell of the brush roll illustrated in FIGS. 1, 2, 3, 5;

FIG. 10 shows the detail, marked in FIG. 9, of the arcuate shell;

FIG. 11 shows a perspective view of a fastening body, seen from its bottom, of the brush roll shown in FIGS. 1, 2, 3, 5;

FIG. 12 shows a perspective view, seen from its head part, of the fastening body shown in FIG. 11;

FIG. 13 shows a side view of the fastening body shown in FIGS. 11, 12; and

FIG. 14 shows a longitudinal sectional view of the fastening body shown in FIGS. 11, 12, 13.

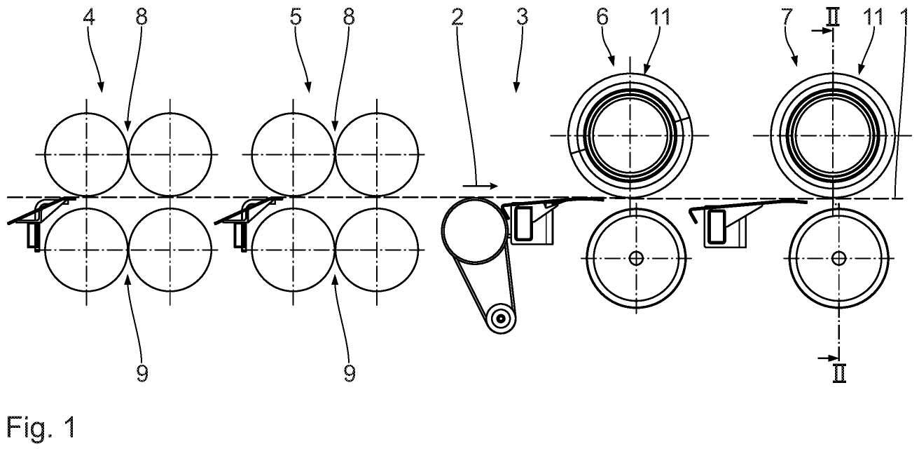

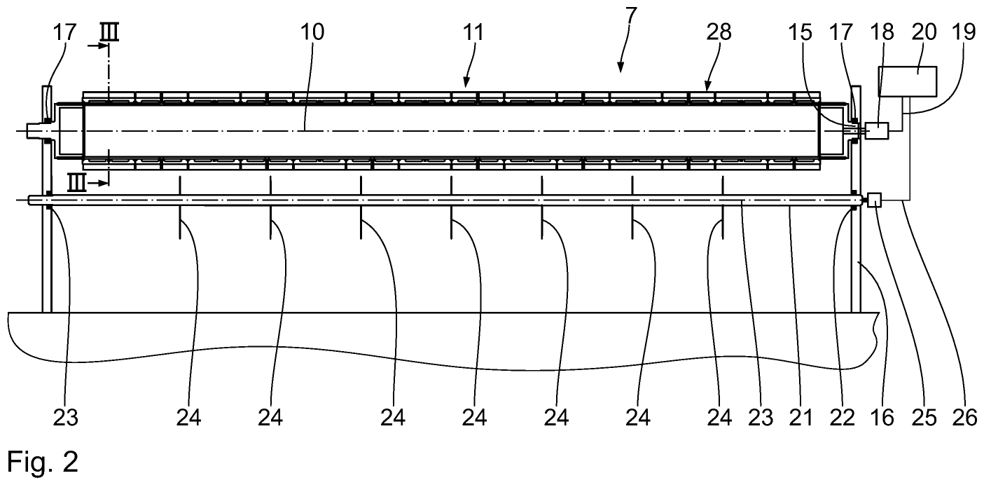

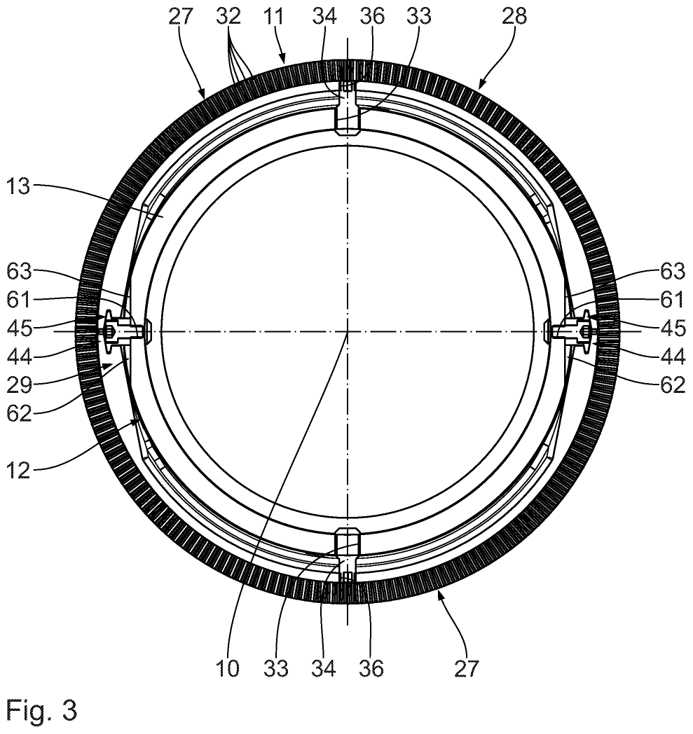

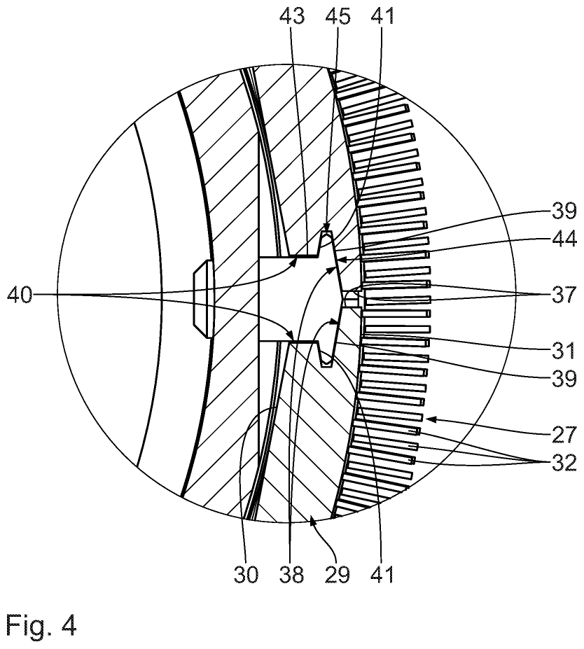

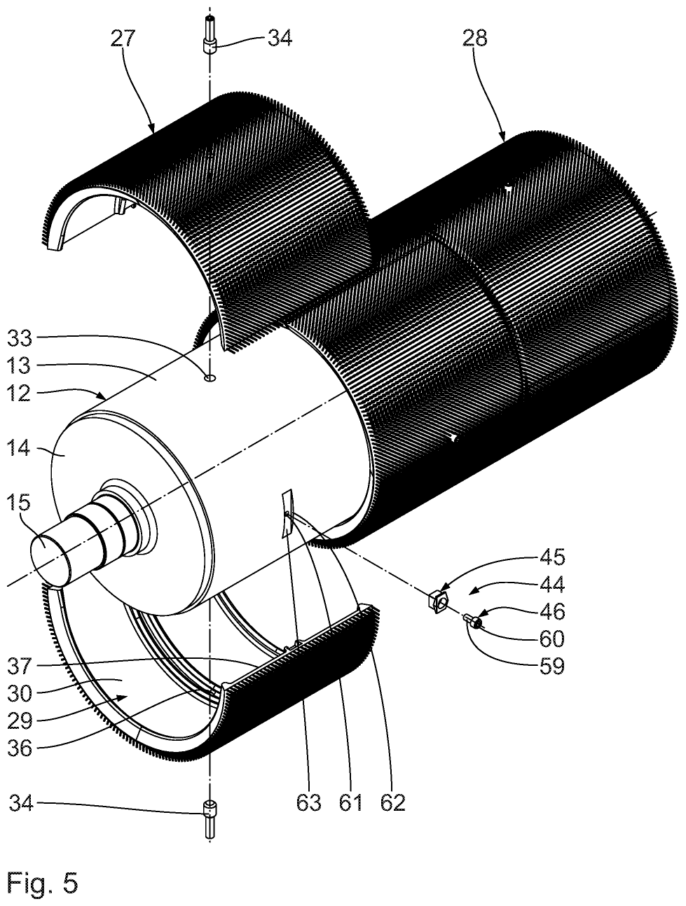

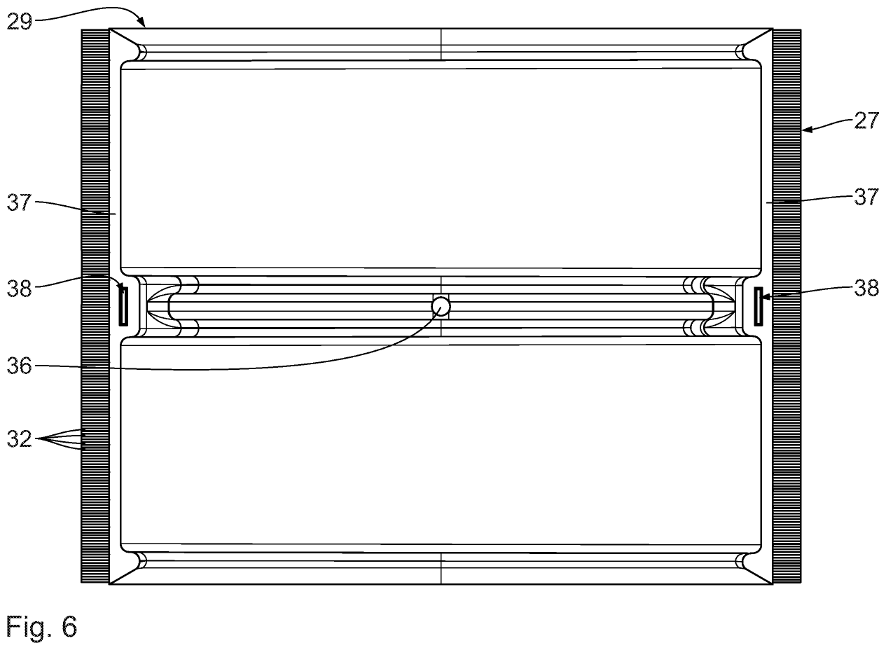

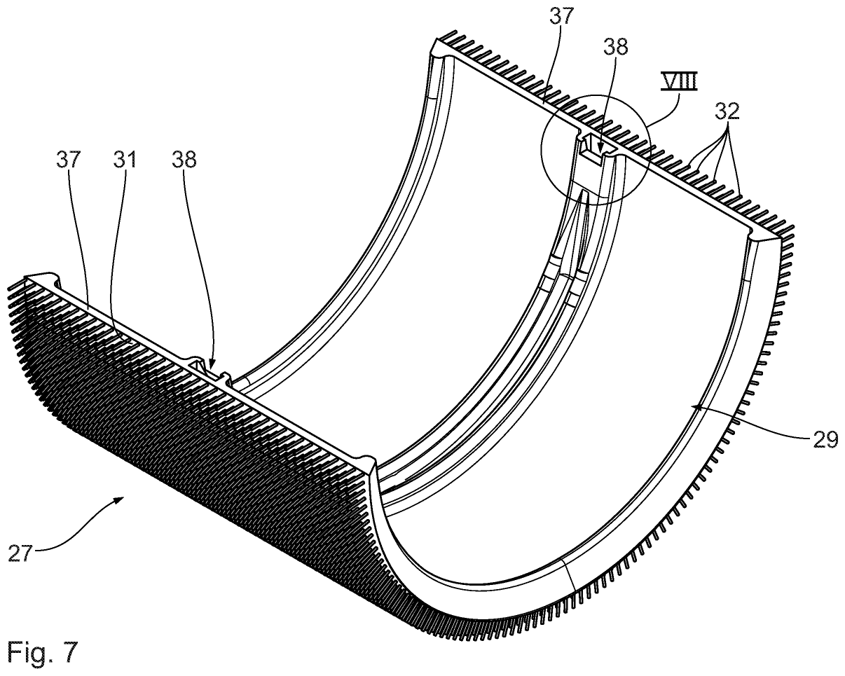

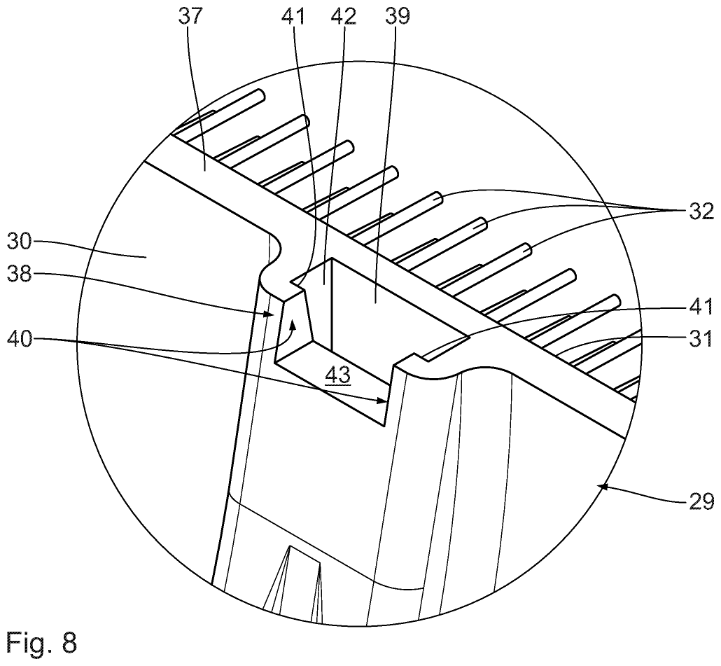

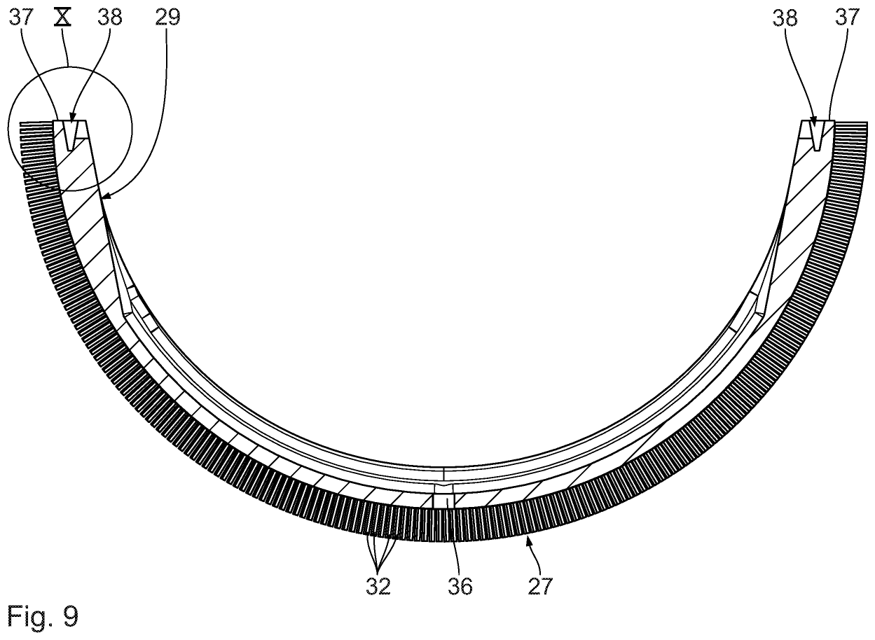

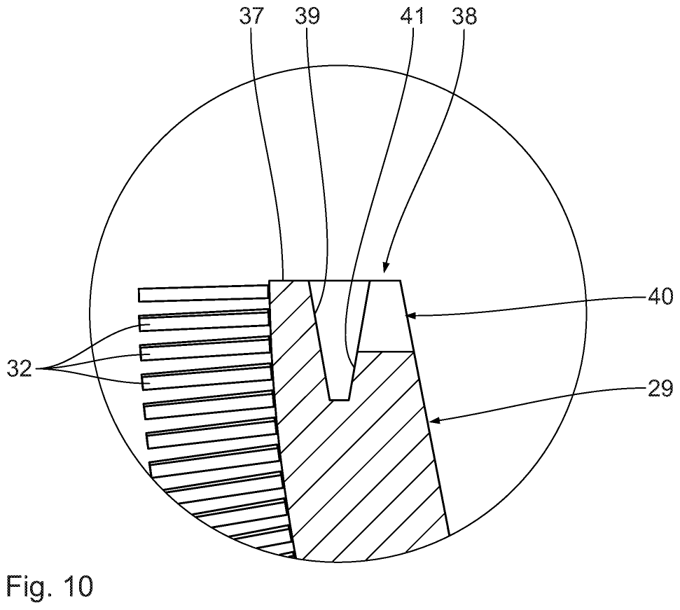

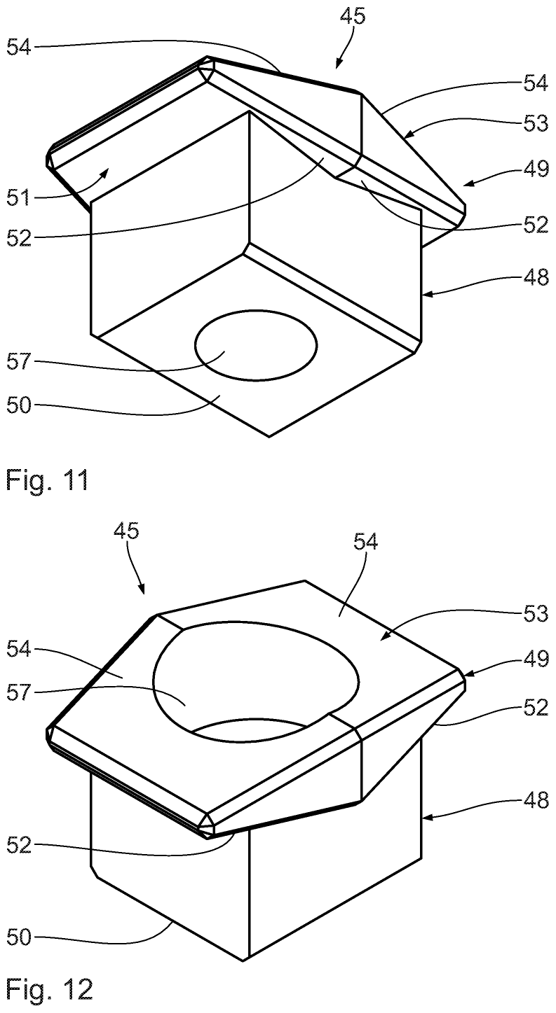

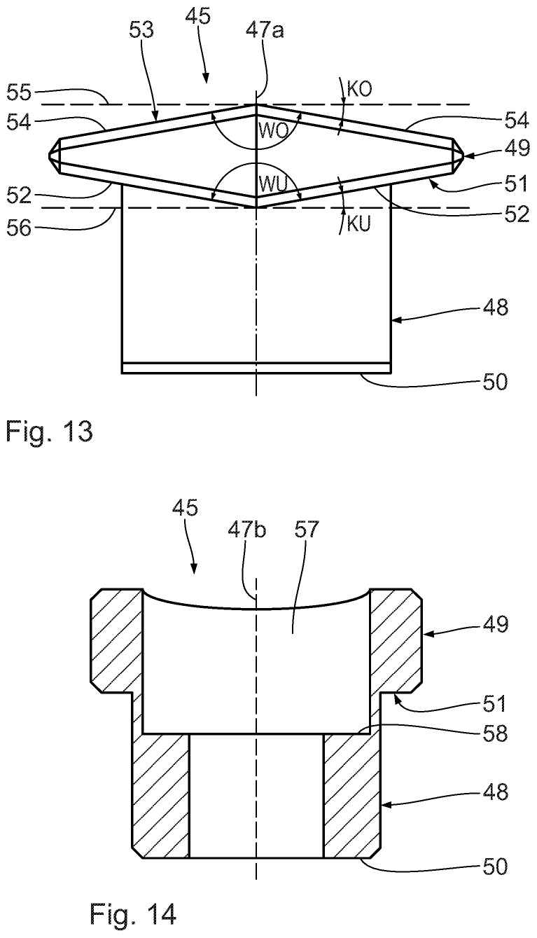

### DESCRIPTION OF THE PREFERRED EMBODIMENT

A corrugated board plant comprises a generally known device for the production of a single-face laminated web of corrugated board, said device being known from EP 0 687 552 A2 or from DE 43 05 158 A1, for example, to which reference is made for more information. In order to form a double-face laminated web of corrugated board, it is common practice to laminate, on the single-face laminated web of corrugated board, a laminating web or at least one additional single-face laminated web of corrugated board from a corresponding additional device, and a laminating web. The double-face laminated web of corrugated board has at least one flat linerboard, at least one corrugated layer and a flat laminating web.

The at least one device for the production of a single-face laminated web of corrugated board and a device for the production of a double-face laminated web 1 of corrugated board from the at least one single-face laminated web of corrugated board and the laminating web, said device in particular being configured as a heating and pulling section, are arranged upstream of a transport device 2 of the double-face laminated web 1 of corrugated board or a longitudinal cutting/creasing assembly 3.

Arranged one behind the other in the transport direction 2, the longitudinal cutting/creasing assembly 3 has a first creasing device 4, a second creasing device 5 and a first cutting device 6 as well as a second cutting device 7.

The creasing devices 4, 5 are configured essentially identically. They each comprise upper creasing tools 8 and lower creasing tools 9. The double-face laminated web 1 of corrugated board is passed through between the upper creasing tools 8 and the lower creasing tools 9. The upper creasing tools 8 and the lower creasing tools 9 of each creasing device 4 or 5 interact to crease the double-face laminated web 1 of corrugated board.

The cutting devices 6, 7 are configured essentially identically. Each cutting device 6 and 7 has a brush roll 11 arranged above the double-face laminated web 1 of corrugated board in such a way as to be rotatable about a brush roll rotary axis 10 or center axis. The brush rolls 11 are configured identically.

Each brush roll 1 has a roll core 12, which in turn comprises a hollow cylindrical roll core jacket 13 and flanges 14 arranged at the ends thereof. Each flange 14 carries a bearing journal 15, which protrudes outwardly and has a circular or annular cross-section.

Each brush roll 11 is mounted on both sides, via the bearing journals 15 and bearings 17, in a frame 16. The bearings 17 are held by the frame 16 and are arranged on the bearing journals 15.

Each brush roll 11 is drivable for rotation by means of a drive motor 18 secured to the frame 16. Each drive motor 18 is connected, via a control line 19, to a control unit 20.

Below the brush rolls 11 and the below the double-face laminated web 1 of corrugated board, knife shafts 21 are mounted for rotation in the frame 16.

On each knife shaft 21, bearings 22 are arranged, which are held by the frame 16. Knife shaft rotary axes 23 run parallel to the brush roll rotary axes 10. In relation to the transport direction 2, each knife shaft rotary axis 23 is arranged slightly downstream of the adjacent brush roll rotary axis 10 associated thereto.

On each knife shaft 21, a plurality of disk-shaped circular knives 24 are arranged non-rotationally in such a way that they are capable of rotating about the knife shaft rotary axis 23 together with the knife shaft 21. The circular knives 24 are displaceable along the respective knife shaft 21. Each knife shaft 21 is drivable for rotation by means of a drive motor 25 secured to the frame 16. Each drive motor 25 is connected, via a control line 26, to the control unit 20.

In each case one brush roll 11 and knife shaft 21 including circular knives 24 are arranged adjacent to one another in such a way as to form a cutting device. The brush rolls 11 and the circular knives 24 associated thereto interact when cutting the double-face laminated web 1 of corrugated board. A brush jacket 28 formed of individual half shells 27 is arranged on each roll core 12. The half shells 27 are arranged in pairs in the circumferential direction of the brush roll 11. In each case two half shells 27 arranged in pairs and adjacent to one another in the circumferential direction of the brush roll 11 extend about the roll core 12 completely in the circumferential direction thereof.

Each half shell 27 has a main body 29 with an inside 30 facing the roll core 12 and an outside 31 facing away from the roll core 12. Each main body 29 is advantageously made of a plastic material.

Each half shell 27 further comprises a plurality of bristles 32, which emanate from the outside 31 of the respective main body 29 and run in a radially outward direction from there. For example, the bristles 32 are combined such as to form a plurality of bundles of bristles. They are preferably arranged in rows running parallel to the respective brush roll rotary axis 10, the rows in turn being arranged in a staggered configuration.

The bristles 32 are flexible and are arranged across the entire outside 31 of the respective main body 29. They are capable of supporting the double-face laminated web 1 of corrugated board during cutting. When cutting the double-face laminated web 1 of corrugated board, the circular knives 24 penetrate the associated brush roll 11, in particular between its bristles 32. In the roll core 12, several pairs of mutually opposing locking pin receiving openings 33 are arranged, which are cylindrical. Each locking pin receiving opening 33 is delimited by a wall of the roll core 12, said wall being provided with an internal thread.

In the assembled condition of the brush roll 11, a locking pin 34 is received in each locking pin receiving opening 33. Each locking pin 34 has an external thread, which engages the internal thread of the associated locking pin receiving opening 33. In the mounted condition, each locking pin 34 protrudes radially outwardly in relation to the associated locking pin receiving opening 33 and engages, from inside, a corresponding cylindrical locking pin recess 36 in the adjacent half shell 27. Each locking pin recess 36 is arranged centrally in the respective half shell 27. Each locking pin 34 ensures that the adjacent half shell 27 is securely mounted in the circumferential direction of the brush roll 11 and in its axial direction in relation to the roll core 12. It is capable of transmitting a torque from the roll core 12 to the adjacent half shell 27.

Each half shell 27 has a partial fastening body receiving opening 38 in each circumferential end region 37, seen in the circumferential direction of the brush roll 11, said partial fastening body receiving openings 38 are open both towards the circumferential end region 37 of a half shell 27 arranged adjacent thereto in the circumferential direction of the brush roll 11 and in the radially inward direction.

Each partial fastening body receiving opening 38 is in each case delimited in the radially outward direction by a plane outer wall 39 of the main body 29. Seen in the circumferential direction of the brush roll 11, the outer wall 39 extends away from the adjacent circumferential end region 37 in an oblique direction facing radially inwardly such that an inwardly facing wedge face is formed.

Each partial fastening body receiving opening 38 is delimited laterally in a radially inward direction by two wedge protrusions 40 of the main body 29, which are spaced from one another in the axial direction of the half shell 27. Each wedge protrusion 40 forms an outwardly facing wedge face 41, which faces the inwardly facing wedge face and is plane. Each outwardly facing wedge face 41 extends at an angle to the opposing inwardly facing wedge face and runs away from the circumferential end region 37 in a radially outward direction running at an angle thereto. Starting from the adjacent circumferential end region 37, each inwardly facing wedge face and the adjacent outwardly facing wedge face 41 associated thereto converge in the circumferential direction of the brush roll 11.

A side wall 42 is formed on each main body 29 between each outwardly facing wedge face 41 and the opposing outer wall 39. Together with the wedge protrusions 40, the side walls 42 delimit the respective partial fastening body receiving opening 38 in the axial direction of the half shell 27.

A respective boundary wall 43 of the main body 29 extends between the two wedge protrusions 40 of a partial fastening body receiving opening 38, said boundary wall 43 being perpendicular to the circumferential direction of the brush roll 11.

In the assembled condition of the brush jacket 28, partial fastening body receiving openings 38 arranged adjacent to each other in the circumferential direction of the brush roll 11 are arranged adjacent to each other in such a way as to be open towards each other. They form joint fastening body receiving openings. The joint fastening body receiving openings and corresponding fastening assemblies 44 ensure that half shells 27 arranged adjacent to each other in the circumferential direction of the brush roll 11 are rigidly connected to each other and fastened to the outside of the roll core 12.

Each fastening assembly 44 comprises a fastening body 45 and a fastening screw 46, which locally fastens the respective fastening body 45 to the roll core 12.

Each fastening body 45 is symmetric in relation to a first center plane 47a and a second center plane 47b, which is perpendicular to the first center plane 47a. It has a block-like or cuboid foot part 48 and a head part 49 rigidly connected to the foot part 48.

Each foot part 48 is configured in an elongate manner. It has a plane free bottom 50. Each head part 49 protrudes beyond the associated foot part 48 on all side faces of the foot part 48 in such a way that a lower side 51 is formed. The lower side 51 faces in the direction of the associated bottom 50.

Each lower side 51 forms two plane lower wedge faces 52, which each extend at an angle relative to one another and to the associated bottom 50. Each lower wedge face 52 runs laterally from outside in the direction of the adjacent bottom 50. In their contact area, which coincides with the first center plane 47a, the lower wedge faces 52 have a minimum distance from the bottom 50.

Each head part 49 further has a roof-like upper side 53, which faces away from the associated bottom 50 and arranged opposite the lower side 51. Each upper side 53 forms two upper wedge faces 54, which run at an angle to one another and to the associated bottom 50. Each upper wedge face 54 is plane. The upper wedge faces 54 of one head part 49 run laterally away from the associated bottom 50 from outside. In a contact area, which coincides with the first center plane 47a, the upper side 53 has a maximum distance from the associated bottom 50. In the first center plane 47a, each head part 49 has a maximum thickness, which reduces evenly in a lateral direction to the outside.

Each upper wedge face 54 forms an upper wedge angle KO with an upper transverse plane 55, said upper wedge angle KO being in the range between 5° and 45°. The upper wedge faces 54 of a fastening body 45 form an upper tip angle WO, which is the range between 145° and 175°. Each lower wedge face 52 forms a lower wedge angle KU with a lower transverse plane 56, said lower wedge angle being in the range between 5° and 45°. The lower wedge faces 52 of a fastening body 45 form a lower tip angle WU, which is between 145° and 175°.

In each fastening body 45, a cylindrical through-opening 57 is formed, which passes through the entire fastening body 45 along the length thereof. The through-opening 57 leads into the bottom 50 and into the upper side 53. In each fastening body 45, the through-opening 57 forms an inner annular shoulder 58 as a result of a change in diameter, said inner annular shoulder 58 being parallel to the bottom 50 and facing away from the associated bottom 50.

Each fastening screw 46 has a threaded shank 59 and a head 60, which is rigidly connected to the threaded shank 59 and protrudes radially outwardly in relation to the threaded shank 59.

In the assembled condition of the brush roll 11, in each case one head 60 is disposed in the associated fastening body 45 and abuts, with its lower side, against the upper side of the annular shoulder 58. The threaded shank 49 extends from the annular shoulder 58 beyond the bottom 50 so as to engage the roll core 12 from outside. The roll core 12 has a respective threaded shank receiving opening 61 configured to receive each threaded shank 59, said threaded shank receiving opening 61 being delimited by a wall of the roll core 12 and forming a threaded connection with the threaded shank 59. A respective internal thread is formed in said wall, which is complementary to an external thread of the threaded shank 59.

Each threaded shank receiving opening 61 emanates from a recess 62 in the roll core 12, which is open radially to the outside and is delimited towards the inside by a plane bottom 63 of the roll core 12.

In the assembled condition of the brush roll 11, the bottom 50 of each fastening body 45 is in a plane contact with the bottom 63 of the associated recess 62 and is pressed against said bottom 63 by the associated fastening screw 46. Mutually opposing side walls of each foot part 48 run adjacent to two side flanks of the associated recess 62 arranged so as to mutually face one another at a distance from one another along the brush roll rotary axis in order to prevent rotation.

Each fastening body 45 engages two half shells 27, arranged adjacent to one another in the circumferential direction of the brush roll 11, via their circumferential end regions 37. It engages the respective joint fastening body receiving opening. It engages the respective partial fastening body receiving openings 38 of said half shells 27.

The boundary walls 43 of two half shells 27 arranged adjacent to one another in the circumferential direction of the brush roll 11 face one another and are adjacent to a fastening body 45 arranged therebetween, in particular to the foot part 48 thereof. Preferably, they abut against the foot part 48 in an opposing manner. Mutually opposing side faces of the wedge protrusions of a partial fastening body receiving opening 38 are adjacent to a fastening body 45 arranged therebetween, in particular to the foot part 48 thereof. Preferably, they abut against the foot part 48 in an opposing manner. The side faces run perpendicular to the boundary wall 43 of the partial fastening body receiving opening 38.

Each lower wedge face 52 engages the outwardly facing wedge faces 41 of a half shell 27 associated thereto in a retaining manner and is in a surfaceto-surface contact therewith. Each upper wedge face 54 engages the inwardly facing wedge face 39 of a half shell 27 associated thereto in a clamping manner and is in a surface-to-surface contact therewith.

The bristles 32 are subject to wear caused by the interaction of the circular knife 24 with the bristles 32. After a certain period of time, it is therefore necessary to replace the bristles 32. For this purpose, the roll core 12 can remain in the associated bearings 17. The half shell/s 27 to be replaced is/are removed from the roll core 12. A new half shell/s 27 is/are mounted in reverse order.

In order to mount the half shells 27, the fastening bodies 34 are fastened to the outside of the roll core 12 by means of the associated fastening screws 46. Each threaded shank 59 has been screwed into the respective threaded shaft receiving opening 61. For this purpose, a hexagon socket is formed in each head 60 of the fastening screws 46.

Then the locking pins 34 are screwed into the roll core 12 via the locking pin receiving openings 33. Alternatively, the locking pins 34 are screwed in first before the fastening bodies 45 are being fastened.

Then the half shells 27 are fitted on the locking pins 34, causing the locking pins 34 to engage the respective locking pin recess 36 in such a way that a pre-centering is performed. Also, this causes the partial fastening body receiving openings 38 to be fitted on the fastening bodies 45 as well.

Analogously, a disassembly takes place in reverse order.

What is claimed is:

1. A brush roll configured to support a material web (1), comprising
a) a roll core (12),
b) arcuate shells (27), which are each
ba) arranged on the roll core (12), and
bb) comprise bristles (32) arranged on an outside, and
c) fastening assemblies (44) configured to fasten the arcuate shells (27) to the roll core (12), with each of the fastening assemblies (44) having
ca) a fastening body (45), which
i) is locally fastened to the roll core (12);
ii) locally fastens at least one of the arcuate shells (27) to the roll core (12),
iii) has a foot part (48) with a bottom (50), said foot part (48) being connected to the roll core (12); and
iv) has a head part (49), connected to the foot part (48), with a lower side (51) facing the roll core (12), said lower side (51) forming at least one lower wedge face (52) for engagement with at least one of the arcuate shells (27).

2. The brush roll as claimed in claim 1, wherein said material web (1) is a web of corrugated board.

3. The brush roll as claimed in claim 1, wherein the at least one lower wedge face (52) forms a lower wedge angle (KU) with a lower transverse plane (56) of the fastening body (45), said lower wedge angle (KU) being in a range between 5° and 45°.

4. The brush roll as claimed in claim 1, wherein the at least one lower wedge face (52) runs towards the bottom (50) of the associated foot part (48) laterally from outside.

5. The brush roll as claimed in claim 1, wherein the head part (49) protrudes laterally in relation to the associated foot part (48) upon forming the at least one lower wedge face (52).

6. The brush roll as claimed in claim 1, wherein each of the fastening assemblies (44) comprises a fastening screw (46), which passes through the fastening body (45) of the associated fastening assembly (44) and locally fastens said fastening body (45) to the roll core (12).

7. The brush roll as claimed in claim 1, wherein the lower side (51) of the respective head part (49) forms two lower wedge faces (52), which engage two arcuate shells (27) arranged adjacent to one another in a circumferential direction of the brush roll (11).

8. The brush roll as claimed in claim 7, wherein the two lower wedge faces (52) run towards the bottom (50) of the associated foot part (48) laterally from outside.

9. The brush roll as claimed in claim 1, wherein each of the fastening bodies (45) has an upper side (53) facing away from the roll core (12), said upper side (53) forming at least one upper wedge face (54) engaging at least one of the arcuate shells (27).

10. The brush roll as claimed in claim 9, wherein the at least one upper wedge face (54) forms an upper wedge angle (KO) with an upper transverse plane (55) of the fastening body (45), said upper wedge angle (KO) being in a range between 5° and 45°.

11. The brush roll as claimed in claim 9, wherein the at least one upper wedge face (54) runs away from the bottom (50) of the associated foot part (48) laterally from outside.

12. The brush roll as claimed in claim 9, wherein the upper side (53) of the respective head part (49) forms two upper wedge faces (54), which engage two arcuate shells (27) arranged adjacent to one another in a circumferential direction of the brush roll (11).

13. The brush roll as claimed in claim 1, wherein at least one outwardly facing wedge face (41) is formed on each of the arcuate shells (27), wherein the at least one lower wedge face (52) of at least one fastening body (45) abuts against said at least one outwardly facing wedge face (41).

14. The brush roll as claimed in claim 1, wherein at least one inwardly facing wedge face (39) is formed on each of the arcuate shells (27), wherein at least one upper wedge face (54) of at least one fastening body (45) abuts against said at least one inwardly facing wedge face (39).

15. The brush roll as claimed in claim 1, wherein the head part (49) protrudes beyond the associated foot part (48) on all side faces of the foot part (48) upon forming the lower side (51).

16. An arcuate shell, comprising at least one outwardly facing wedge face (41) for interaction with at least one lower wedge face (52) of at least one fastening body (45).

17. The arcuate shell as claimed in claim 16, wherein it is intended for a brush roll configured to support a material web, comprising
a) a roll core,
b) arcuate shells, which are each
ba) arranged on the roll core, and
bb) comprise bristles arranged on an outside, and
c) fastening assemblies configured to fasten the arcuate shells to the roll core, with each of the fastening assemblies having
ca) a fastening body, which
i) is locally fastened to the roll core;
ii) locally fastens at least one of the arcuate shells to the roll core,
iii) has a foot part with a bottom, said foot part being connected to the roll core; and
iv) has a head part, connected to the foot part, with a lower side facing the roll core, said lower side forming at least one lower wedge face for engagement with at least one of the arcuate shells.

18. A fastening body for local fastening to a roll core of a brush roll and for locally fastening at least one arcuate shell to the roll core, comprising
a) a foot part with a bottom, and
b) a head part, connected to the foot part, with a lower side, wherein said lower side forms at least one lower wedge face for engagement with at least one arcuate shell.

19. The fastening body as claimed in claim 18, wherein it is intended for a brush roll configured to support a material web, comprising
a) a roll core,
b) arcuate shells, which are each
ba) arranged on the roll core, and
bb) comprise bristles arranged on an outside, and
c) fastening assemblies configured to fasten the arcuate shells to the roll core, with each of the fastening assemblies having
ca) a fastening body, which
i) is locally fastened to the roll core;
ii) locally fastens at least one of the arcuate shells to the roll core,
iii) has a foot part with a bottom, said foot part being connected to the roll core; and
iv) has a head part, connected to the foot part, with a lower side facing the roll core, said lower side forming at least one lower wedge face for engagement with at least one of the arcuate shells.

20. A cutting device
a) with at least one knife, and
b) with at least one brush roll as claimed in claim 1 to support a material web when cutting said material web using the at least one knife.

21. A corrugated board plant with at least one brush roll as claimed in claim 1.
